(19) United States
(12) Patent Application Publication
(10) Pub. No.: US 2017/0118786 A1
(43) Pub. Date: Apr. 27, 2017

(54) TECHNIQUES FOR SINGLE-RADIO SIMULTANEOUS LTE AND UMTS CALLS

(71) Applicant: QUALCOMM Incorporated, San Diego, CA (US)

(72) Inventors: Sony AKKARAKARAN, Poway, CA (US); Sharad SAMBHWANI, San Diego, CA (US)

(21) Appl. No.: 15/214,075

(22) Filed: Jul. 19, 2016

Related U.S. Application Data
(60) Provisional application No. 62/247,126, filed on Oct. 27, 2015.

(51) Int. Cl. H04W 76/02; H04W 72/14; H04W 76/04

(52) U.S. Cl. CPC H04W 76/025; H04W 76/048; H04W 72/14

(57) ABSTRACT

Techniques for providing single-radio simultaneous or concurrent LTE and UMTS calls are described herein. An example method may include determining that a voice call is to be carried on dedicated channel (DCH) enhancements over a first radio network. In another aspect, the example method may include determining that a data call is to be carried over a second radio network. In an aspect, the example method may apply when the second radio network is different from the first radio network. In another aspect, the example method may include reconfiguring the data call to a discontinuous state, wherein the discontinuous state operates within a DCH enhancements discontinuous period. In an aspect, the example method may also include conducting the voice call over DCH enhancements and the data call in the discontinuous state using a single radio.

### CROSS-REFERENCE TO RELATED APPLICATION

This application claims the benefit of U.S. Provisional Application Ser. No. 62/247,126, entitled “SINGLE-RADIO SIMULTANEOUS LTE AND UMTS” and filed on Oct. 27, 2015, which is expressly incorporated by reference herein in its entirety.

### BACKGROUND

Aspects of the present disclosure relate generally to wireless communication systems, and more particularly, to simultaneous or concurrent single-radio communications of voice and data calls.

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Mobile Telecommunications System (UMTS) Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

Another telecommunication standard is Long Term Evolution (LTE) which is a set of enhancements to the UMTS mobile standard promulgated by 3GPP. LTE is designed to support mobile broadband access through improved spectral efficiency, lowered costs, and improved services using orthogonal frequency-division multiple access (OFDMA) on the downlink, single-carrier frequency-division multiple access (SC-FDMA) on the uplink, and multiple-input multiple-output (MIMO) antenna technology. As the demand for mobile broadband access continues to increase, research and development continue to advance the UMTS technologies not only to meet the growing demand for mobile broadband access, but also to advance and enhance the user experience with mobile communications.

For a UMTS and LTE-capable user equipment (UE) connected to a LTE data call, a simultaneous or a concurrent voice call is possible on LTE if the UE and at least one of the associated networks support voice-over-LTE (VoLTE). Otherwise, circuit-switched fall-back (CSFB) may be required. In an aspect, when the LTE data call may be dropped or ended, the UMTS and LTE-capable UE may switch to UMTS to handle the voice call. In an aspect, a method in which both the LTE data call and the UMTS voice call may occur simultaneously would require the UE to have at least two radios (e.g., dual radio chains), for example, a first transmit/receive radio chain for UMTS and a second transmit/receive radio chain for LTE. In this case, the UE may become more complicated and/or cost more. Accordingly, improvements in the manner a UE handles voice and data calls may be desirable.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its purpose is to present some concepts of one or more aspects in a simplified form as a prelude to the more detailed description that is presented later.

According to an example, a method for simultaneous or concurrent single-radio communications of voice and data calls by a user equipment (UE) is provided. The method includes determining that a voice call is to be carried on dedicated channel (DCH) enhancements over a first radio network, determining that a data call is to be carried over a second radio network, wherein the second radio network is different from the first radio network, reconfiguring the data call to a discontinuous state, wherein the discontinuous state may operate within a DCH enhancements discontinuous period, and conducting the voice call over DCH enhancements and the data call in the discontinuous state using a single radio.

In another example an apparatus (e.g., a UE) for simultaneous or concurrent single-radio communications of voice and data calls is provided. The apparatus includes means for determining that a voice call is to be carried on dedicated channel (DCH) enhancements over a first radio network, means for determining that a data call is to be carried over a second radio network, wherein the second radio network may be different from the first radio network, means for reconfiguring the data call to a discontinuous state, wherein the discontinuous state may operate within a DCH enhancements discontinuous period, and means for conducting the voice call over DCH enhancements and the data call in the discontinuous state using a single radio.

In another example, an apparatus (e.g., a UE) for simultaneous or concurrent single-radio communications of voice and data calls is provided. The apparatus may include a memory configured to store instructions, and at least one processor coupled to the memory. The at least one processor and the memory are configured to determine that a voice call is to be carried on dedicated channel (DCH) enhancements over a first radio network, determine that a data call is to be carried over a second radio network, wherein the second radio network may be different from the first radio network, reconfigure the data call to a discontinuous state, wherein the discontinuous state may operate within a DCH enhancements discontinuous period, and conduct the voice call over DCH enhancements and the data call in the discontinuous state using a single radio.

In a further example, a computer-readable medium (e.g., a non-transitory computer-readable medium) associated with at least one processor storing computer executable code for simultaneous or concurrent single-radio communications of voice and data calls is provided. The computer-readable medium includes computer executable code to determine that a voice call is to be carried on dedicated channel (DCH) enhancements over a first radio network, determine that a data call is to be carried over a second radio network, wherein the second radio network may be different from the first radio network, reconfigure the data call to a discontinuous state, wherein the discontinuous state may operate within a DCH enhancements discontinuous period, and conduct the voice call over DCH enhancements and the data call in the discontinuous state using a single radio.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 is a schematic diagram illustrating an example of features of a user equipment for conducting single-radio communications of voice and data calls in accordance with various aspects of the present disclosure.

FIGS. 2A and 2B is a flow diagram illustrating an exemplary method for single-radio communications of voice and data calls according to one or more of the presently described aspects.

FIG. 3 is a timing diagram conceptually illustrating an example of conducting single-radio communications of voice and data calls according to one or more of the presently described aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

When referred to hereafter, the terminology “user equipment” or “UE” includes but is not limited to a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In addition, the UE may be a cellular phone, a personal digital assistant (PDA), a wireless modem, a wireless communication device, a handheld device, a tablet computer, a laptop computer, a cordless phone, a wireless local loop (WLL) station, a global positioning system (GPS) device, a multimedia device, a video device, a digital audio player (e.g., MP3 player), a camera, a game console, a wearable computing device (e.g., a smart-watch, smart-glasses, a health or fitness tracker, etc), an appliance, a sensor, a vehicle communication system, a medical device, a vending machine, a device for the Internet-of-Things, or any other similar functioning device, or any other type of user device capable of operating in a wireless environment. When referred to hereafter, the terminology “network entity” includes but is not limited to a base station, a Node B, an evolved Node B, a mobile Node B, a UE (e.g., communicating in peer-to-peer or ad-hoc mode with another UE), a site controller, an access point (AP), or substantially any type of component that can communicate with a UE to provide wireless network access at the UE, or any other type of interfacing device capable of operating in a wireless environment.

For a UMTS and LTE-capable a user equipment (UE) connected in an LTE data call, a simultaneous or a concurrent voice call is possible on LTE if the UE and at least one of the associated networks support voice-over-LTE (VoLTE). Otherwise, circuit-switched fall-back (CSFB) may be required. In an aspect, the LTE data call may be dropped or ended, and the UMTS and LTE-capable UE may switch to UMTS to handle the voice call. In an aspect, a method in which both the LTE data call and the UMTS voice call may occur simultaneously would require the UE to have at least two radios (e.g., dual radio chains), for example, a first transmit/receive radio chain for UMTS and a second transmit/receive radio chain for LTE. In this case, the UE may become more complicated and/or cost more. It may be desirable to have simultaneous or concurrent LTE and UMTS capability without adding a second transmit/receive radio chain to the UE.

The disclosure, in an aspect, provides for conducting single-radio simultaneous or concurrent voice and data calls, for example, an UMTS voice call and an LTE data call. In an aspect, when a voice call is to be carried on dedicated channel (DCH) enhancements, instead of switching from LTE to UMTS for an LTE data call, the LTE data call may be reconfigured to a new discontinuous-operation state so that both the voice call over the DCH enhancements and the LTE data call in the new discontinuous-operation state may be carried on concurrently together.

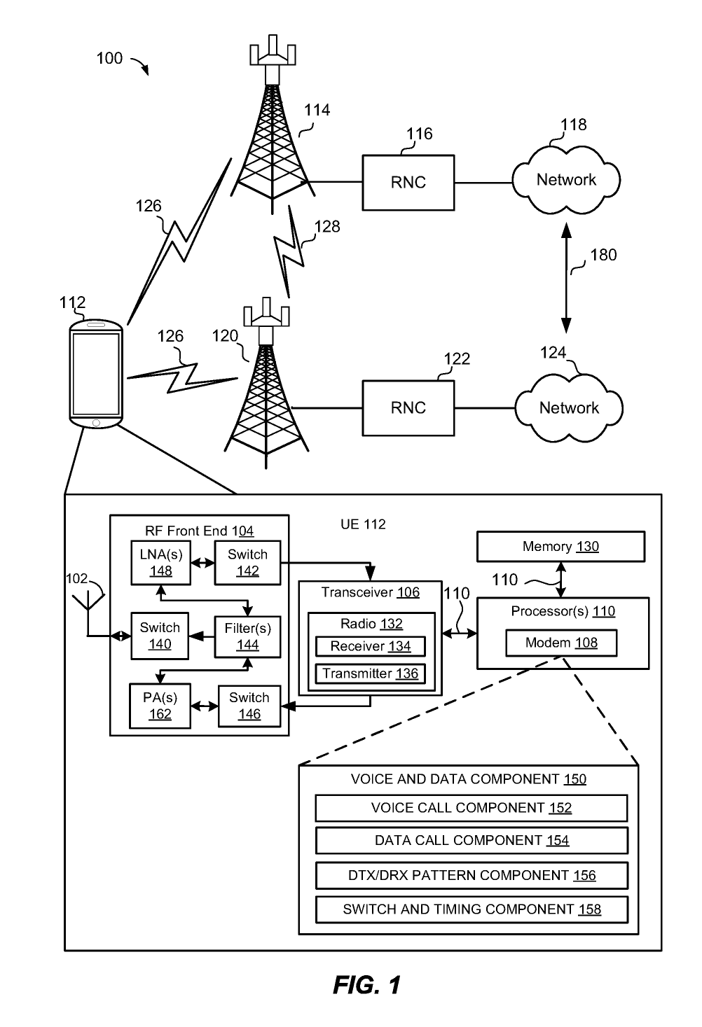

Referring to FIG. 1, in an aspect, a wireless communication system 100 includes at least one user equipment (UE) 112 in communication coverage of a first network entity 114 (e.g., a base station, a Node B, or a cell thereof, in an UMTS network). The UE 112 may communicate with a first network 118 via the first network entity 114 and a first radio network controller (RNC) 116. In some aspects, multiple UEs including UE 112 may be in communication coverage with one or more network entities, including network entity 114. In another aspect, in the wireless communication system 100, the UE 112 may be in communication coverage of a second network entity 120 (e.g., a base station, a Node B, or a cell thereof, in an LTE network). The UE 112 may communicate with a second network 124 via the second network entity 120 and a second RNC 122. In some aspects, multiple UEs including UE 112 may be in communication coverage with one or more network entities, including network entity 120. In some aspects, the first network (e.g., an UMTS network) and/or the second network (e.g., an LTE network) may comprise one or more network entities, including network entity 114 and/or network entity 120. In another aspect, the network entity 114 and the network entity 120 may communicate via a communication link 128 (e.g., a backhaul link). In an aspect, the first network 118 and the second network 124 may communicate and/or share information via a communication link 180 (e.g., a core telecommunications network and/or the Internet).

In an aspect, the network entity 114 or network entity 120 may be a base station in an UMTS HSPA network, or an eNodeB in a long term evolution (LTE) network 124 including an evolved packet core (EPC) (not shown). Although various aspects are described in relation to a UMTS HSPA network, similar principles may be applied in an LTE network, Evolution-Data Optimized (EV-DO) network, or other wireless wide area networks (WWAN), or a core telecommunications network and/or the Internet. The wireless network may employ a scheme where multiple network entities may transmit on a channel. By way of example, UE 112 may transmit and/or receive wireless communications to and/or from network entity 114 and/or network entity 120. In an aspect, the UE 112 may operate in a connected mode (e.g., CELL DCH state). For example, the UE 112 may be actively communicating with network entity 114 and/or network entity 120.

In some aspects, the first network entity 114 (e.g., an UMTS base station) may communicate the timing for UE transmissions/receptions with the second network entity 120 (e.g., an LTE eNodeB), for example, via the communication link 128. In some other aspects, the first network entity 114 (e.g., an UMTS base station) and the second network entity 120 (e.g., an LTE eNodeB) may negotiate a timing agreeable to both. For example, there may be some timing flexibility possible in the first radio network 118 (e.g., an UMTS network), and the communication between the first network entity 114 (e.g., an UMTS base station) and the second network entity 120 (e.g., an LTE eNodeB) may support the UE 112 to re-tune its transceiver between the first network entity 114 and the second network entity 120 (or an UMTS network and an LTE network), as well as to determine or adjust UMTS timing drift due to UE 112 mobility.

According to the present aspects, UE 112 may include one or more processors 110 that may operate in combination with a voice and data component 150 to provide single-radio simultaneous or concurrent LTE and UMTS operations (e.g., concurrent LTE data calls and UMTS voice calls). For example, the voice and data component 150 may reconfigure an LTE data call so that the LTE data call and an UMTS voice call may be carried on concurrently. In an aspect, the term “component” as used herein may be one of the parts that make up a system, may be hardware, firmware, and/or software, and may be divided into other components. Further, the voice and data component 150 may be communicatively coupled to a transceiver 106, which may include a radio 132 having a receiver 134 for receiving and processing radio frequency (RF) signals and a transmitter 136 for processing and transmitting RF signals. The voice and data component 150 may include a voice call component 152, a data call component 154 and a discontinuous transmission/discontinuous reception (DTX/DRX) pattern component 156. The data call component 154 may determine that voice is carried on, for example, dedicated channel (DCH) enhancements. The data call component 154 may configure a data call to a new state (e.g., a new discontinuous-operation state). The discontinuous transmission/discontinuous reception (DTX/DRX) pattern component 156 may determine aspects of the DTX/DRX pattern to adjust or modify the concurrent operations of voice and data calls, and the switch and timing component 158 may configure the periods for switching between the voice call and the data call, and adjusts or modifies the timing for the concurrent operations of voice and data calls. The processor 110 may be coupled to the transceiver 106 and a memory 130 via at least one or more bus 110.

The receiver 134 may include hardware, firmware, and/or software code executable by a processor for receiving data, the code comprising instructions and being stored in a memory (e.g., computer-readable medium). The receiver 134 may be, for example, a radio frequency (RF) receiver. In an aspect, the receiver 134 may receive signals transmitted by the network entity 114. The receiver 134 may obtain measurements of the signals. For example, the receiver 134 may determine Ec/Io, SNR, etc.

The transmitter 136 may include hardware, firmware, and/or software code executable by a processor for transmitting data, the code comprising instructions and being stored in a memory (e.g., computer-readable medium). The transmitter 136 may be, for example, an RF transmitter.

In an aspect, UE 112 may have two receive radio chains and one transmit radio chain. For example, receiver 134 (or two receiver which is not shown) of the UE 112 may have two receive radio chains (e.g., one for UMTS and one for LTE), and transmitter 136 may have one transmit radio chain (e.g., UMTS or LTE). In this case, UE 112 may simultaneously receive both LTE data call and UMTS voice call, however only one call (e.g., LTE data call or UMTS voice call) may be transmitted at a time.

In an aspect, the one or more processors 110 may include a modem 108 that uses one or more modem processors. The various functions related to voice and data component 150 may be included in modem 108 and/or processors 110 and, in an aspect, may be executed by a single processor, while in other aspects, different ones of the functions may be executed by a combination of two or more different processors. For example, in an aspect, the one or more processors 110 may include any one or any combination of a modem processor, or a baseband processor, or a digital signal processor, or a transmit processor, or a transceiver processor associated with transceiver 106. In particular, the one or more processors 110 may implement components included in the voice and data component 150. In another aspects, some of the features of the modem 108 may be performed by the radio 132. In another aspect, the radio 132 is configured to support single-radio simultaneous or concurrent LTE and UMTS operations for data and voice calls.

The voice call component 152 and/or the data call component 154 may include hardware, firmware, and/or software code executable by a processor (e.g. processor 110), where the hardware may include, for example, a hardware accelerator, or a specialized processor.

The DTX/DRX pattern component 156 and/or the switch and timing component 158 may include hardware, firmware, and/or software code executable by a processor (e.g. processor 110), where the hardware may include, for example, a hardware accelerator, or a specialized processor.

In an aspect, the UE 112 may include a RF front end 104 and a transceiver 106 for receiving and transmitting radio transmissions, for example, wireless communications 126 transmitted by the network entity 114 and/or the network entity 120. The RF front end 104 may be connected to one or more antennas 102 and may include one or more low-noise amplifiers (LNAs) 148, one or more switches 140, 142, 146, one or more power amplifiers (PAs) 162, and one or more filters 144 for transmitting and receiving RF signals. In an aspect, components of the RF front end 104 may connect with the transceiver 106. The transceiver 106 may connect to one or more modems 108 and the processor 110 via at least a bus 110.

In an aspect, one or more LNAs 148 may amplify a received signal at a desired output level. In an aspect, each LNA 148 may have a specified minimum and maximum gain values. In an aspect, the RF front end 104 may use one or more switches 142, 140 to select a particular LNA 148 and its specified gain value based on a desired gain value for a particular application.

In another example, one or more PA(s) 162 may be used by the RF front end 104 to amplify a signal for an RF output at a desired output power level. In an aspect, each PA 162 may have a specified minimum and maximum gain values. In an aspect, the RF front end 104 may use one or more switches 140, 146 to select a particular PA 162 and its specified gain value based on a desired gain value for a particular application.

Also, for example, one or more filters 144 may be used by the RF front end 104 to filter a received signal to obtain an input RF signal. Similarly, in an aspect, for example, a respective filter 144 may be used to filter an output from a respective PA 162 to produce an output signal for transmission. In an aspect, each filter 144 may be connected to a specific LNA 148 and/or PA 162. In an aspect, the RF front end 104 may use one or more switches 140, 142, 146 to select a transmit or receive path using a specified filter 144, LNA 148, and/or a PA 162, based on a configuration as specified by the transceiver 106 and/or the processor 110.

The transceiver 106 may be configured to transmit and receive wireless signals through the antenna 102 via the RF front end 104. In an aspect, transceiver may be tuned to operate at specified frequencies such that the UE 112 may communicate with, for example, the network entity 114 or the network entity 120. For example, the modem 108 may configure the transceiver 106 to operate at a specified frequency and power level based on the UE configuration of the UE 112 and communication protocol used by the modem 108.

In an aspect, the modem 108 may be a multiband-multimode modem, which can process digital data and communicate with the transceiver 106 such that the digital data is sent and received using the transceiver 106. In an aspect, the modem 108 may be multiband and be configured to support multiple frequency bands for a specific communications protocol. In an aspect, the modem 108 can be multimode and be configured to support multiple operating networks and communications protocols. In an aspect, the modem 108 can control one or more components of the UE 112 (e.g., the RF front end 104, the transceiver 106) to enable transmission and/or reception of signals from the network based on a specified modem configuration. In an aspect, the modem configuration can be based on the mode of the modem and the frequency band in use. In another aspect, the modem configuration can be based on the UE configuration information associated with the UE 112 as provided by the network during cell selection and/or cell reselection.

The UE 112 may further include a memory 130, such as for storing data used herein and/or local versions of applications or voice and data component 150 and/or one or more of its subcomponents being executed by the processor 110. The memory 130 may include any type of computer-readable medium usable by a computer or the processor 110, such as random access memory (RAM), read only memory (ROM), tapes, magnetic discs, optical discs, volatile memory, non-volatile memory, and any combination thereof. For example, the memory 130 may be a computer-readable storage medium that stores one or more computer-executable codes defining the voice and data component 150 and/or one or more of its subcomponents, and/or data associated therewith, when the processor 110 executes the voice and data component 150 and/or one or more of its subcomponents. In another aspect, the memory 130 may be a non-transitory computer-readable storage medium.

For example, the UE 112, the processor 110, and/or the voice and data component 150 may be configured to exploit or take advantage of the discontinuities in UMTS transmission/reception in order to remain in LTE and UMTS connected state. In an aspect, when a voice call is carried on Rel-99 DCH in UMTS, there are no discontinuities in UMTS transmission/reception. In another aspect, when a voice call is carried on Rel-12 DCH enhancements, discontinuities in UMTS transmission/reception may exist, and may be exploited. Specifically, in basic mode of DCH Enhancements, for a significant fraction of the time, transmit/receive operations may take place in time windows (e.g., 10 ms) and may alternate with same (e.g., 10 ms) or other time windows in which there is neither transmission nor reception (e.g., during DTX/DRX period). Thus, instead of switching back from LTE to UMTS, the LTE data call is reconfigured to a new discontinuous-operation state, wherein LTE transmit and receive operations only happen in a restricted time-window that lies within the DCH enhancements DTX/DRX period (e.g., 10 ms). In an aspect, timing information for the LTE operation window is communicated from the first network entity 114 (or an UMTS network 118) to the second network entity 120 (or an LTE network 124) via the communication link 128.

In another aspect, the LTE operation window does not occupy the entire DCH enhancements DTX/DRX period (e.g., 10 ms) in UMTS, but a subset of the DCH enhancements DTX/DRX period, in order to include at least an allowance for the UE 112 to re-tune its transceiver between UMTS and LTE, and/or for UMTS timing drift due to UE mobility. Then, both UMTS voice call over DCH enhancements and LTE data call (in the new discontinuous state) may be carried on concurrently, with the UE 112 switching between the voice call and the data call periodically (e.g., every 10 ms).

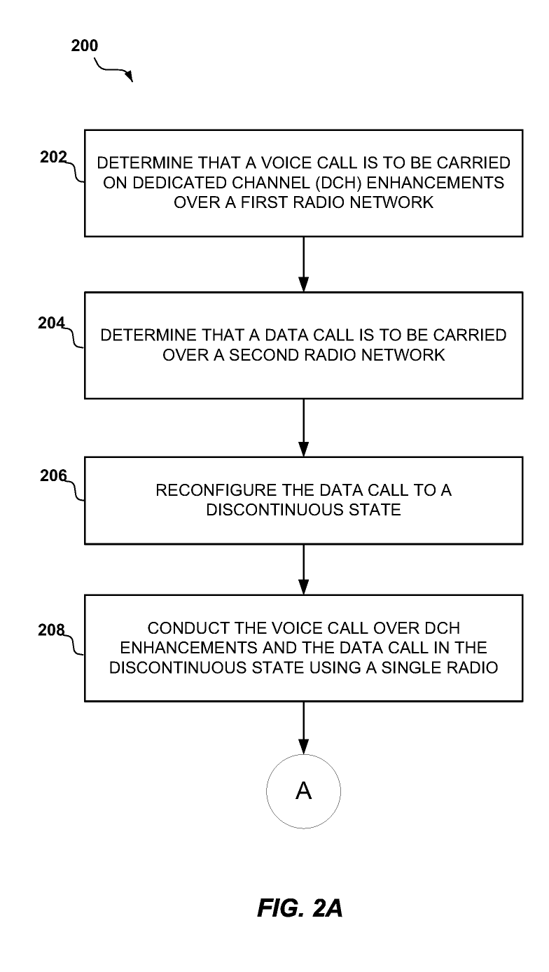

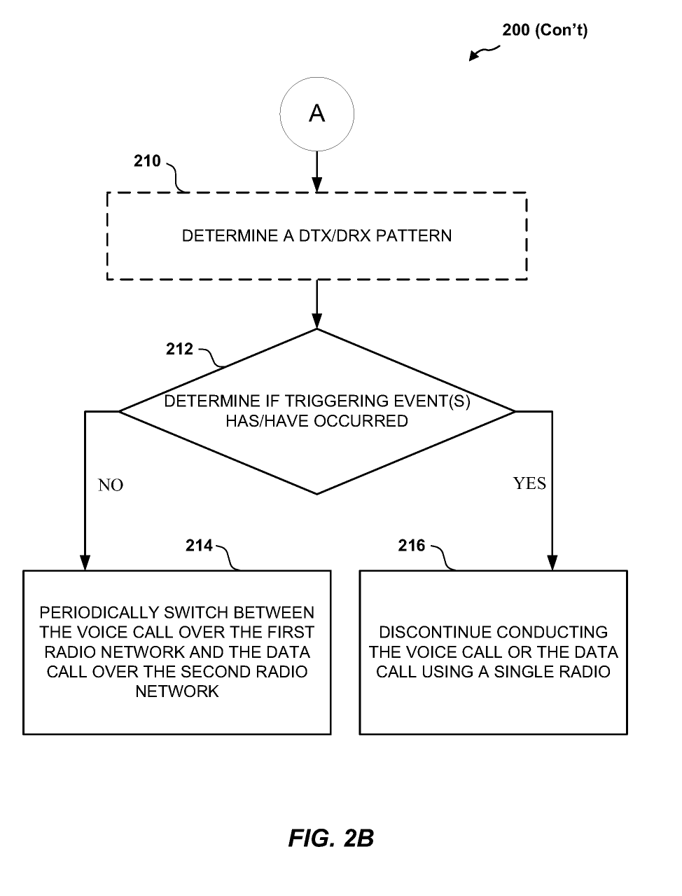

Referring to FIGS. 2A and 2B, in an operational aspect, the UE 112 (FIG. 1) may perform one aspect of a method 200 for single-radio simultaneous or concurrent voice call and data call operations. While, for purposes of simplicity of explanation, the method is shown and described as a series of acts, it is to be understood and appreciated that the method (and further methods related thereto) is/are not limited by the order of acts, as some acts may, in accordance with one or more aspects, occur in different orders and/or concurrently with other acts from that shown and described herein. For example, it is to be appreciated that a method could alternatively be represented as a series of interrelated states or events, such as in a state diagram. Moreover, not all illustrated acts may be required to implement a method in accordance with one or more features described herein. In method 200, blocks indicated as dashed boxes represent optional features.

In an aspect, at block 202, the method 200 may include determining that a voice call is to be carried on dedicated channel (DCH) enhancements over a radio network (e.g., UMTS). For example, the processor 110 and/or the voice call component 152 within the voice and data component 150 (FIG. 1) may determine whether there is a voice call, and whether the voice call is to be carried on DCH enhancements (e.g., Rel-12 DCH enhancements) over a first radio network (e.g., UMTS).

In an aspect, at block 204, the method 200 may include determining that a data call is to be carried over another radio network (e.g., LTE). For example, the processor 110 and/or the data call component 154 within the voice and data component 150 (FIG. 1) may determine whether there is a data call, and whether the data call is to be carried over a second radio network (e.g., LTE) that is different from the first radio network (e.g., UMTS).

In an aspect, at block 206, the method 200 may include reconfiguring the data call to a discontinuous state. For example, the processor 110, the voice and data component 150, the data call component 154, and/or the DTX/DRX pattern component 156 (FIG. 1) may reconfigure an LTE data call to a new discontinuous-operation state. The new discontinuous state may operate within a DCH enhancements discontinuous period, for example, a DCH enhancements DTX/DRX period (e.g., 10 ms).

In an aspect, at block 208, the method 200 may include conducting the voice call over DCH enhancements and the data call in the discontinuous state using a single radio. For example, the processor 110, the voice and data component 150, the modem 108, the transceiver 106, and/or the radio 132 (FIG. 1) may support conducting the concurrent performance of both the voice call over DCH enhancements (e.g., UMTS voice call) and the data call (e.g., LTE data call) in a discontinuous state using a single radio.

In an aspect, at block 210, the method 200 may include determining a DTX/DRX pattern, which may be used to identify different cases of simultaneous or concurrent voice and data calls (or UMTS/LTE) operation. For example, the DTX/DRX pattern component 156 (FIG. 1) may determine the DTX/DRX pattern for concurrent voice and data calls (over UMTS and/or LTE) operation.

In another aspect, at block 212, the method 200 may include determining whether at least a triggering event has occurred. The operation as described here may monitor both the voice call over UMTS and the data call over LTE. For example, the processor 110, the voice and data component 150, the modem 108, the transceiver 106, and/or the radio 132 may detect a triggering event(s).

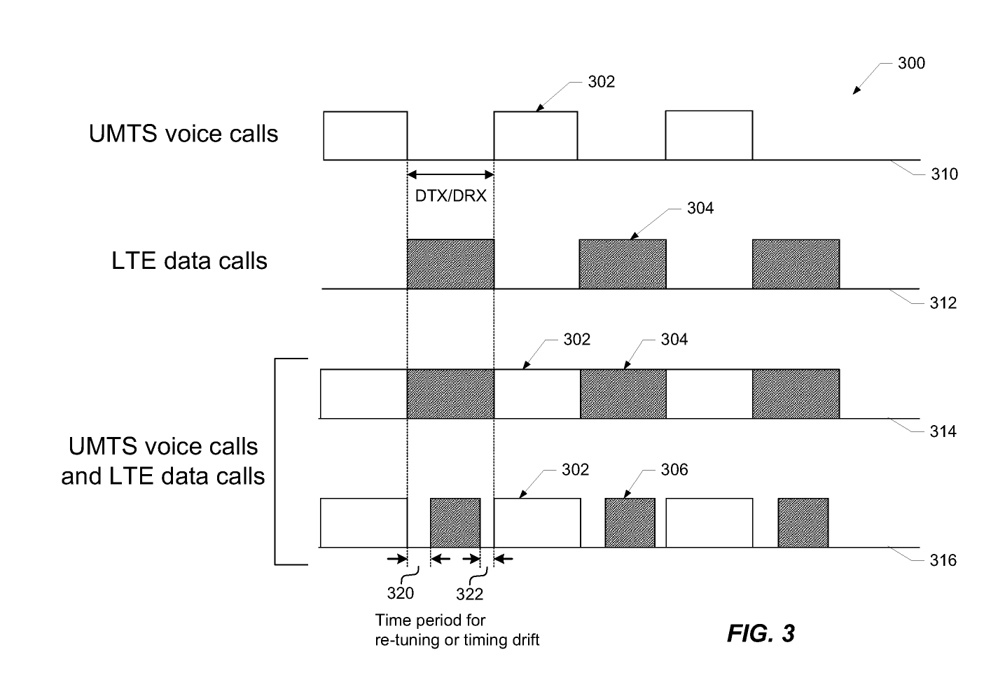

In an aspect, method 200 may proceed to block 214 in response to a triggering event not occurring or being detected at block 212. At block 212, the method 200 may include periodically switching between the voice call over UMTS and the data call over LTE. This periodically switching is also illustrated in FIG. 3. For example, the processor 110, the voice and data component 150 and/or the switch and timing component 158 may support switching between the voice call and the data call.

In another aspect, method 200 may proceed to block 216 in response to a triggering event occurring or being detected at block 212. In this case, the method 200 may include discontinuing conducting the voice call or the data call (e.g., drop or end the data call). For example, the processor 110, the voice and data component 150 and/or the switch and timing component 158 may support the discontinuation of performing the voice call and the data call together or concurrently.

In an aspect, DCH enhancements specification may require the UMTS-capable UE to change the alternate DTX/DRX pattern (e.g., 10 ms) in certain conditions or events, and these conditions or events may affect simultaneous or concurrent voice and data calls operation. In addition, these conditions or events may be considered as triggering events discussed below.

In an aspect, when UMTS voice call needs to fall back from DCH enhancements to Rel-99 DCH, the LTE data call may be dropped or ended, since Rel-99 DCH waveforms may not have any discontinuous transmission periods. The LTE data call may be dropped or ended. for example, due to UMTS handover to a Node B not supporting DCH enhancements, or due to triggering of compressed-mode in case the UE capability may not support DCH enhancements together with compressed mode.

In another aspect, when UE supporting DCH enhancements with compressed mode needs a portion of the DTX/DRX duration (e.g., 10 ms) in order to do compressed-mode measurements, the LTE data call may be dropped or ended. Another option is for the UMTS network to indicate the compressed mode parameters to the LTE network, and the transmit/receive times allowed for LTE are further restricted to account for this. In the option of dropping the LTE call, the LTE data call may be re-established in the discontinuous mode once the UMTS compressed-mode duration is over.

In an aspect, when signaling radio bearer (SRB) transmissions over downlink DCCH is required for UMTS, the UMTS-capable UE receiver may need to be on for a continuous 40 ms DCCH duration. SRB transmissions are rare (e.g., 1%) but not easily predictable sufficiently in advance. Thus the option of dropping the LTE call when they occur may not be desirable, and it may be difficult for the UMTS Node B to inform the LTE e-NodeB in advance of the upcoming UMTS downlink (DL) DCCH transmission. In this case, LTE may suffer a downlink outage during the second 10 ms of the DCCH duration. This downlink outage could be indicated on the LTE uplink via control signaling after the first 10 ms, so that LTE can be aware of the upcoming downlink outage at the last 10 ms of the UMTS DL DCCH duration. The LTE downlink outage could cause some loss in LTE performance.

In another aspect, when a UE cannot decode the 10 ms DL voice packet on UMTS, the UE does not know whether there is a voice packet that failed decoding due to poor SNR, or whether it is a voice packet together with DL SRB on DCCH, for which different decoding parameters are to be used and 20 ms reception is needed. Thus, LTE could suffer some DL outage even when SRB is not actually transmitted on UMTS DL, because the UE believes there may be an SRB.

In an aspect, when UMTS UE is uplink (UL) coverage-limited, the UE may switch to 20 ms transmissions (e.g., by switch and timing component 158) for both UL and DL, which may imply complete absence of DTX/DRX opportunities similar to Rel-99 DCH. The switching between 10 ms and 20 ms transmissions could be dynamic every 20 ms transmission time interval (TTI). In an aspect, the LTE data calls may suffer outages for sporadic 20 ms UMTS transmissions, and the LTE data calls may be dropped or ended if there are too many outages. In another aspect, the UE or the network may disable the 10 ms/20 ms switching for UMTS, or to reduce the likelihood of 20 ms transmissions by appropriate choice of parameters that govern the 10 ms/20 ms selection/switching algorithm, however, this disablement or reduction may reduce the coverage for the voice call. It is also possible to combine the above two aspects. In an aspect, the UE may forcibly stay in 10 ms at the first instance where a switch to 20 ms would have normally been required, and may use the following 10 ms LTE uplink to signal the outage to LTE network. The UE 112 may also convey an estimate of how long it is expected to stay in 20 ms mode, based on UE's transmit power history.

In another aspect, the schemes as described above may apply to the basic mode of DCH Enhancements. In the full mode of DCH Enhancements, the amount of DTX/DRX time available may be equal or less than 10 ms, as the amount of DTX/DRX time available in UMTS depends on when the downlink (DL) decoding ends. In this case, it may be harder to pre-allocate the gaps during which LTE transmissions can occur. In an aspect, a conservative estimate may be used, together with LTE outages whenever UMTS exceeds these estimates. In another aspect, the simultaneous or concurrent voice and data calls (e.g., UMTS voice call and/or LTE data call) operation described herein may be limited to basic mode of DCH Enhancements.

The apparatus may include additional components that perform each of the blocks of the algorithm in the aforementioned flowcharts of FIG. 2A and FIG. 2B. As such, each block in the aforementioned flowcharts of FIG. 2A and FIG. 2B may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

Referring to FIG. 3, in an operational aspect, an exemplary timing diagram 300 represents conducting single-radio simultaneous or concurrent voice and data calls, for example, conducting an UMTS voice call and an LTE data call using a single radio. In an aspect, voice call component 152 may be, for example, configured to transmit/receive a voice call (e.g., UMTS voice call 302) on dedicated channel (DCH) enhancements (e.g., 310). In another aspect, data call component 154 may be, for example, configured or reconfigured to a new discontinuous-operation state, for transmitting/receiving a data call (e.g., an LTE data call 304) during UMTS DTX/DRX periods 312. In an aspect, for example, the transceiver 106, the processor 110, the voice and data component 150, the voice call component 152, the data call component 154, the DTX/DRX pattern component 156, and/or the switch and timing component 158 (in FIG. 1) may be configured to perform the voice call over the UMTS DCH enhancements and the LTE data call in the new discontinuous-operation state simultaneously or concurrently on 314 or 316. In an aspect, the switch and timing component 158 may be configured to switch between the voice call and the data call periodically on 314 or 316.

In particular, in an example, the DTX/DRX pattern component 156 and/or the switch and timing component 158 may be configured to perform the UMTS voice call and the LTE data call simultaneously or concurrently on 314, with a first 10 ms time window for transmitting/receiving UMTS voice call 302, and a second 10 ms time window immediately after the first 10 ms time window for transmitting/receiving LTE data call 304. In an aspect, the switch and timing component 158 may be configured to switch between the voice call and the data call periodically on 314 (e.g., switch every 10 ms).

In another example, the DTX/DRX pattern component 156 and/or the switch and timing component 158 may be configured to perform the UMTS voice call and the LTE data call simultaneously or concurrently on 316, with a first 10 ms time window for transmitting/receiving UMTS voice call 302. Immediately after the first 10 ms time window, in an aspect, a second 10 ms time window may include at least a period 320 and/or a period 322 for re-tuning the transceiver 106 of the UE 112 between multiple networks (e.g., UMTS and/or LTE networks) associated with the UE 112. In another aspect, the second 10 ms time window may include at least a period 320 and/or a period 322 for timing drift(s) in a radio network (e.g., UMTS or LTE) due to UE mobility, and the LTE data call 306. In an aspect, the switch and timing component 158 may be configured to switch between the voice call and the data call periodically on 316 (e.g., switch every 10 ms), and the transceiver 106 may be configured to transmit/receive LTE data call 306 in every other 10 ms time window.

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, or the like.

Several aspects of a telecommunications system have been presented with reference to one or more wireless communication systems (e.g., UMTS system, LTE system). As those skilled in the art will readily appreciate, various aspects described throughout this disclosure may be extended to other telecommunication systems, network architectures and communication standards.

By way of example, various aspects may be extended to other UMTS systems such as High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

Similarly, it is to be understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, or of 35 U.S.C. §112(f), unless the element is expressly recited using the phrase “means for” or, in the case of a method claim, the element is recited using the phrase “step for.”

What is claimed is:

1. A method for a user equipment (UE) in wireless communications, comprising:
determining, by the UE, that a voice call is to be carried on dedicated channel (DCH) enhancements over a first radio network;
determining, by the UE, that a data call is to be carried over a second radio network, wherein the second radio network is different from the first radio network;
reconfiguring, at the UE, the data call to a discontinuous state, wherein the discontinuous state operates within a DCH enhancements discontinuous period; and
conducting, at the UE, the voice call over DCH enhancements and the data call in the discontinuous state using a single radio.

2. The method of claim 1, further comprising:
periodically switching, at the UE, between the voice call over the first radio network and the data call over the second radio network.

3. The method of claim 1, wherein the voice call is to be carried on a basic mode or a full mode of DCH enhancements.

4. The method of claim 1, wherein the DCH enhancements discontinuous period is less than or equal to a DCH enhancements discontinuous transmission (DTX)/discontinuous reception (DRX) period.

5. The method of claim 4, wherein the DCH enhancements discontinuous period includes at least a period to re-tune a transceiver of the UE between the first radio network and the second radio network or a timing drift in the first radio network due to UE mobility.

6. The method of claim 1, wherein the DCH enhancements discontinuous period is communicated from the first radio network to the second radio network.

7. The method of claim 1, further comprising discontinuing the conducting the voice call or the data call in response to:
the voice call over the first radio network falls back from DCH enhancements to Rel-99 DCH;
the UE supporting DCH enhancements with compressed mode needs a part of the DCH enhancements discontinuous period in order to do compressed-mode measurements;
the voice call over the first radio network requires at least a signaling radio bearer (SRB) transmission over a downlink dedicated control channel (DCCH);
the UE cannot decode a downlink voice packet over the first radio network; or
the voice call over the first radio network has limited coverage on uplink, and/or the UE switches to another state for both uplink and downlink transmissions.

8. The method of claim 1, wherein the first radio network is an Universal Mobile Telecommunications System (UMTS) network, and the second radio network is a long term evolution (LTE) network.

9. An apparatus for wireless communications, comprising:
means for determining that a voice call is to be carried on dedicated channel (DCH) enhancements over a first radio network;
means for determining that a data call is to be carried over a second radio network, wherein the second radio network is different from the first radio network;
means for reconfiguring the data call to a discontinuous state, wherein the discontinuous state operates within a DCH enhancements discontinuous period; and
means for conducting the voice call over DCH enhancements and the data call in the discontinuous state using a single radio.

10. The apparatus of claim 9, further comprising:
means for periodically switching between the voice call over the first radio network and the data call over the second radio network.

11. The apparatus of claim 9, wherein the voice call is to be carried on a basic mode or a full mode of DCH enhancements.

12. The apparatus of claim 9, wherein the DCH enhancements discontinuous period is less than or equal to a DCH enhancements discontinuous transmission (DTX)/discontinuous reception (DRX) period.

13. The apparatus of claim 12, wherein the DCH enhancements discontinuous period includes at least a period to re-tune a transceiver of the apparatus between the first radio network and the second radio network or a timing drift in the first radio network due to apparatus mobility.

14. The apparatus of claim 9, further comprising means for discontinuing the conducting the voice call or the data call in response to:
the voice call over the first radio network falls back from DCH enhancements to Rel-99 DCH;
the apparatus supporting DCH enhancements with compressed mode needs a part of the DCH enhancements discontinuous period in order to do compressed-mode measurements;
the voice call over the first radio network requires at least a signaling radio bearer (SRB) transmission over a downlink dedicated control channel (DCCH);
the apparatus cannot decode a downlink voice packet over the first radio network; or
the voice call over the first radio network has limited coverage on uplink, and/or the apparatus switches to another state for both uplink and downlink transmissions.

15. The apparatus of claim 9, wherein the first radio network is an Universal Mobile Telecommunications System (UMTS) network, and the second radio network is a long term evolution (LTE) network.

16. An apparatus for wireless communications, comprising:
a memory configured to store instructions; and
at least one processor coupled to the memory, the at least one processor and the memory are configured to execute the instructions to:
determine that a voice call is to be carried on dedicated channel (DCH) enhancements over a first radio network;
determine that a data call is to be carried over a second radio network, wherein the second radio network is different from the first radio network;
reconfigure the data call to a discontinuous state, wherein the discontinuous state operates within a DCH enhancements discontinuous period; and
conduct the voice call over DCH enhancements and the data call in the discontinuous state using a single radio.

17. The apparatus of claim 16, wherein the at least one processor and the memory are further configured to execute the instructions to:
periodically switch between the voice call over the first radio network and the data call over the second radio network.

18. The apparatus of claim 16, wherein the voice call is to be carried on a basic mode or a full mode of DCH enhancements.

19. The apparatus of claim 16, wherein the DCH enhancements discontinuous period is less than or equal to a DCH enhancements discontinuous transmission (DTX)/discontinuous reception (DRX) period.

20. The apparatus of claim 19, wherein the DCH enhancements discontinuous period includes at least a period to re-tune a transceiver of the apparatus between the first radio network and the second radio network or a timing drift in the first radio network due to apparatus mobility.

21. The apparatus of claim 16, wherein the DCH enhancements discontinuous period is communicated from the first radio network to the second radio network.

22. The apparatus of claim 16, wherein the at least one processor and the memory are further configured to execute the instructions to:
discontinue conducting the voice call or the data call in response to:
the voice call over the first radio network falls back from DCH enhancements to Rel-99 DCH;
the apparatus supporting DCH enhancements with compressed mode needs a part of the DCH enhancements discontinuous period in order to do compressed-mode measurements;
the voice call over the first radio network requires at least a signaling radio bearer (SRB) transmission over a downlink dedicated control channel (DCCH);
the apparatus cannot decode a downlink voice packet over the first radio network; or
the voice call over the first radio network has limited coverage on uplink, and/or the apparatus switches to another state for both uplink and downlink transmissions.

23. The apparatus of claim 16, wherein the first radio network is an Universal Mobile Telecommunications System (UMTS) network, and the second radio network is a long term evolution (LTE) network.

24. A computer-readable medium storing computer executable code, comprising code to:
determine that a voice call is to be carried on dedicated channel (DCH) enhancements over a first radio network;
determine that a data call is to be carried over a second radio network, wherein the second radio network is different from the first radio network;
reconfigure the data call to a discontinuous state, wherein the discontinuous state operates within a DCH enhancements discontinuous period; and
conduct the voice call over DCH enhancements and the data call in the discontinuous state using a single radio.

25. The computer-readable medium of claim 24, further comprising code to:
periodically switch between the voice call over the first radio network and the data call over the second radio network.

26. The computer-readable medium of claim 24, wherein the voice call is to be carried on a basic mode or a full mode of DCH enhancements.

27. The computer-readable medium of claim 24, wherein the DCH enhancements discontinuous period is less than or equal to a DCH enhancements discontinuous transmission (DTX)/discontinuous reception (DRX) period.

28. The computer-readable medium of claim 27, wherein the DCH enhancements discontinuous period includes at least a period to re-tune a transceiver of a user equipment (UE) between the first radio network and the second radio network or a timing drift in the first radio network due to UE mobility.

29. The computer-readable medium of claim 24, further comprising code to: discontinue conducting the voice call or the data call in response to:
the voice call over the first radio network falls back from DCH enhancements to Rel-99 DCH;
a user equipment (UE) supporting DCH enhancements with compressed mode needs a part of the DCH enhancements discontinuous period in order to do compressed-mode measurements;
the voice call over the first radio network requires at least a signaling radio bearer (SRB) transmission over a downlink dedicated control channel (DCCH);
the UE cannot decode a downlink voice packet over the first radio network; or
the voice call over the first radio network has limited coverage on uplink, and/or the UE switches to another state for both uplink and downlink transmissions.

30. The computer-readable medium of claim 24, wherein the first radio network is an Universal Mobile Telecommunications System (UMTS) network, and the second radio network is a long term evolution (LTE) network.
